(19) United States
(12) Patent Application Publication
(10) Pub. No.: US 2015/0350091 A1
(43) Pub. Date: Dec. 3, 2015

(54) System and method for concurrently sharing GSM coverage by mobile operators and for implementing local switching without impact on core networks

(71) Applicants: Dmitry SOLOVYEV, Moscow (RU); Leonid ARBATMAN, Mountain View, CA (US)

(72) Inventors: Dmitry SOLOVYEV, Moscow (RU); Leonid ARBATMAN, Mountain View, CA (US)

(21) Appl. No.: 14/726,582

(22) Filed: May 31, 2015

Related U.S. Application Data
(60) Provisional application No. 62/006,423, filed on Jun. 2, 2014.

(51) Int. Cl. H04L 12/815; H04W 36/22; H04W 72/04; H04W 28/10; H04W 8/06; H04W 16/14

(52) U.S. Cl. CPC H04L 47/22; H04W 8/06; H04W 16/14; H04W 72/0406; H04W 28/10; H04W 36/22; H04W 84/042

(57) ABSTRACT

A System to perform concurrent GERAN sharing with local switching and traffic shaping, comprising BSC-proxy (proxy base station controller), being connected as a regular BSC (base station controller) to one or multiple PLMNs (public land mobile networks); plurality of BSCs, geographically co-located with BTSs (base transceiver stations) and interfaced to BSC-proxy by A-over-IP and traffic shaping software; and optional signaling probes for GSM MAP (mobile application part). Methods providing concurrent sharing of radio access network and local switching connectivity without involving mobile network cores.

### CROSS REFERENCE TO RELATED APPLICATIONS

This application claims the benefit of U.S. application Ser. No. 62/006,423, filed Jun. 2, 2014, the disclosure of which is incorporated by reference herein.

### FIELD OF THE INVENTION

Mobile networking for extending cellular coverage and concurrent sharing between multiple mobile networks and for providing local switching connectivity within radio access network.

### BACKGROUND OF THE INVENTION

A segment of a conventional mobile network contains a MSC/VLR (mobile swithing cener/visitor location register) that couples a number of base station controllers (BSC) by means of so-called GSM A-interface, that can be implemented as TDM- or IP-based (time division multiplex- or Internet protocol). Each BSC serves multiple base stations (BTS), connected over an A-bis interface, that can be also carried over TDM or IP communication links.

When a segment of radio access network (RAN) is connected by a link with expensive or limited resources, and the essential volume of traffic is interconnected within a given area, optimizing amount of data transferred over such a backhaul is a critical challenge. It can be either a link between MSC/VLR and BSC, or in between a BSC and a BTS. An A-interface is exhaustively specified and it can unify equipment by different vendors, while an A-bis interface in between BSC and BTS has vendor-specific flavor.

There is a challenge to provide GSM EDGE radio access network (GERAN) coverage in low-traffic area. The common practice is either infrastructure sharing between operators, or roaming model (ie coverage is provided by one operator and the remained subscribers are served as roamers, with both visitor and serving networks interconnected by means of signaling system #7 mobile application part—SS7 MAP protocol), or by coverage of a single operator with limited services (emergency calls only) for other subscribers.

GSM radio access network (GERAN) sharing is unspecified by a standard. It includes a chain consisting of a BTS and a BSC, and it is hosted by a single MSC/VLR belonging to a given mobile network (PLMN—public land mobile network). Each BTS emits a single pair of a mobile country code (MCC) and a mobile network code (MNC) that is a native obstacle for sharing GSM radio access network. A-interface signaling messages also carry fields that identify the given GERAN.

U.S. Pat. No. 7,561,879 B2 describes usage of pseudo—PLMN at air interface to identify radio access network being shared among core networks, as well as the behavior of a communication device to chose a core network.

US 20040105429 A1 Patent contains methods of sharing network elements from radio access networks between core networks, where dedicated resources (e.g. frequencies) are exclusively allocated for each network.

U.S. Pat. No. 7,236,784 B2 Patent describes a system with a shared radio access network, while it assumes that a wireless device chooses a PLMN to be used.

U.S. Pat. No. 7,280,516 B1 Patent discloses a network architecture for an arrangement in which mobile terminals may have at least two functional modes of operation in which the functional modes are provided by at least two core networks having different functionality.

As a state of the art, the standard interface between GERAN and a network core is a so-called A-interface that is either a conventional TDM or over IP. In any case, an application level protocol at an A-interface operates with mobile identifications like IMSI (international mobile subscriber identity) or TMSI (temporary mobile subscriber identity), while subscribers are using MSISDN (mobile station integrated services digital network number) numbering. At the BSC side there is no knowledge about MSISDN-IMSI relations, and a legacy BSC is not specified to provide local switching by itself. A conventional TDM-based A-interface functions in such a way, that a call leg passes through an interface, so MSC is involved in a voice path in any case, even when both subscribers are being served by the same BTS or adjacent BTSs. This issue can be eliminated if a network follows a so-called NGN (next generation networks) architecture, so both call legs are represented by corresponding endpoints that can be enforced to use the same codecs, and IP traffic can be switched directly between BTSs. Nevertheless, this approach fails in the case of a conventional MSC.

An example of a local switching implementation, controlled on core network side, can be found in US 20120178453 A1 Patent, and base station subsystem (BSS)-side procedures to provide aimed local connectivity can be found in the U.S. Pat. No. 8,559,949 B2.

### SUMMARY OF THE INVENTION

In one embodiment the invention provides a system that comprises of a BSC-proxy, coupled with one or multiple MSC/VLRs belonging to different PLMNs, and multiple BSCs, connected to a BSC-proxy with traffic-shaping software and co-located with BTSs. Optional signaling probes monitor GSM MAP signaling between MSC/VLRs and HLRs(home location register).

For each MSC/VLR, the BSC-proxy emulates a conventional BSC which provides a radio access network (RAN) extension for the given PLMN, routes traffic between BSCs and MSC/VLRs and replaces signaling parameters in such a way that the GERAN segment is accepted as being exclusively controlled by each of MSC/VLRs and serves own subset of subscribers.

Co-locating BSCs and BTSs eliminates the conventional practice of transferring radio resource management procedures over a backhaul that is assumed to be in between a BSC and a BTS.

From a BSC perspective, the BSC-proxy performs as a single MSC/VLR. The BSC-proxy implements local switching functionality without any support on any MSC/VLR, and enables traffic shaping software to reduce signaling and voice traffic being transferred over a backhaul between BSC-proxy and BSC. The BSC-proxy performs local switching within the complete GERAN extension, regardless which BSCs and MSC/VLRs are involved in controlling call legs being switched.

Signaling probes provide MSISDN-IMSI pairs to the BSC-proxy to implement local switching.

In another embodiment, the invention provides a method of transparent GERAN sharing, where a BSC-proxy routes SCCP (signaling Connection Control Part) messages and transactions between BSCs and MSC/VLRs based on IMSIs and TMSIs of subscribers being served. In order to unambiguously correlate a TMSI to a PLMN, the BSC-proxy re-allocates TMSIs locally and keeps TMSI-IMSI knowledge to ensure proper routing. The BSC-proxy replaces signaling parameters like Location Area Identification and Cell Identification, as well as CIC(channel identification code) values. Thus, all BTSs in a given GERAN extension are emitting either a dedicated MCC/MNC or ones from one of the extended network. Functioning that way, the BSC-proxy is accepted by all MSCs involved just as a regular BSC belonging to a corresponding PLMN.

In another embodiment, the invention provides a method of proving local switching within GERAN extension, served by BSC-proxy, based on IMSI-MSISDN knowledge, where on each mobile-originated (MO) call attempt a calling party number is converted to IMSI, and the mentioned IMSI is charged. For each mobile-terminated (MT) call, the calling party is checked against a list of charged IMSIs, and if found, local switching is implemented either within the location served by BSC or between BSCs. If a MT call to a charged IMSI contains a calling party number, this number is also converted to IMSI and verified to match the MO call leg.

In another embodiment a method is provided of obtaining IMSI-MSISDN relation by means of GSM mobile application part (MAP) signaling monitoring between MSC/VLRs and HLRs.

In another embodiment, a method is provided of obtaining IMSI-MSISDN by means of emulating a virtual subscriber, as if being served by BSC-proxy, and making a fake call on behalf of a newly-appeared subscriber after performing Location Update procedure within GERAN extension. Thus, a MT call to a virtual subscriber contains a needed MSISDN as a calling party number.

In another embodiment, a method is provided of obtaining IMSI-MSISDN by means of getting MSISDN in response of an emulated USSD (unstructured supplementary service data) request on behalf of a newly-appeared subscriber after performing Location Update procedure.

In another embodiment, a method is provided to start tracking TMSI-IMSI correlation, when BSC-proxy rejects a Location Update attempt, done by an unknown TMSI, to force a subscriber to use IMSI instead.

In another embodiment, a method Is provided to start tracking TMSI-IMSI correlation by means of initiating a MAP_SEND_IDENTIFICATION procedure to a VLR from a BSC-proxy.

In another embodiment, a method is provided of canceling a local switching procedure when a lawful interception is applied for any call leg by means of either keeping a list of subscribers being monitored or requesting from a corresponding node a permission for each call to perform local switching.

In another embodiment, a method is provided of canceling local switching procedure upon request, e.g. when LBS (location-based services) data is requested for any of call legs being involved.

To provide packet data service, the same radio access network sharing principles as described above for A-interface proxying and multiplexing, can be also be applied for sharing GERAN between several core networks.

### DESCRIPTION OF DRAWINGS

FIG. 1 illustrates the block diagram of a system in accordance with the invention.

FIG. 2 is a flow diagram of a method for processing a Location Update request in a BSC-proxy, when selecting a host PLMN for serving the given subscriber.

FIG. 3 shows examples of signaling parameters of A-interfaces, that are substituted within BSC-proxy.

FIG. 4 is a simplified flow diagram of local switching as implemented in BSC-proxy.

FIG. 5 illustrates local switching within the system of FIG. 1 for the case when subscribers belong to two different operators-legs of a call being switched are served by two different PLMNs.

### DETAILED DESCRIPTION OF PREFERRED EMBODIMENTS

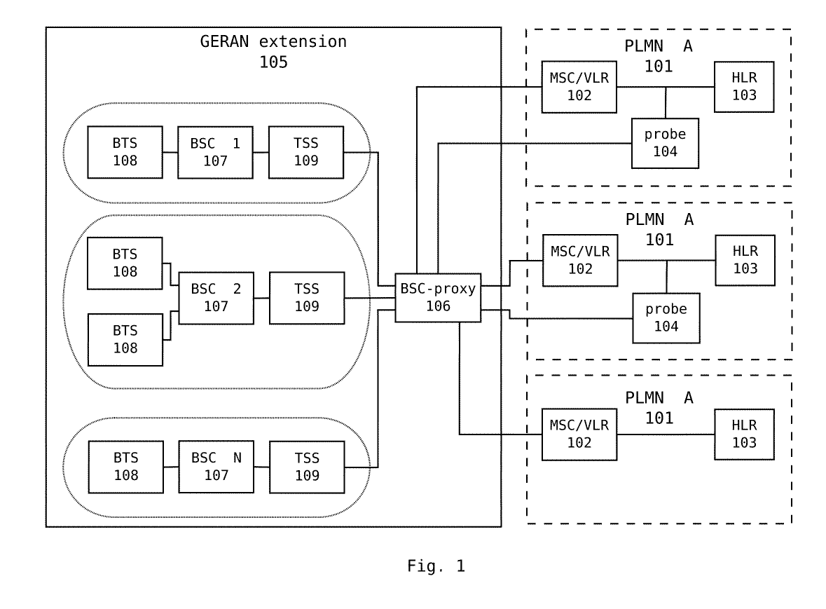

FIG. 1 is a block diagram of a system in accordance with the invention aimed at extending mobile network coverage for one or several PLMNs 101 in such a way that each PLMN assumes the given GERAN extension to be exclusively under its control and without noticing subscribers belonging to other PLMNs being also extended.

A BSC-proxy 106 provides a proper option of a GSM A-interface to each PLMN, where A-interface signaling can be carried either over conventional SS7 layers, or SIGTRAN (signaling transport), or as A-over-IP, and media is carried either over conventional TDM or is RTP-packetized (real-time transport protocol) and controlled by means of MGCP (media gateway control protocol) or MEGACO (media gateway control). For each MSC/VLR 102 being coupled , the BSC-proxy is seen as a regular BSC that is exclusively controlled.

BSC-proxy 106 provides an A-over-IP signaling interface to BSCs 107 with media being shaped by traffic shaping software 109. BSC-proxy 106 is seen by BSC 107 as a regular MSC/VLR, and the traffic shaping software 109 exposes RTP+MGCP to BSC 107.

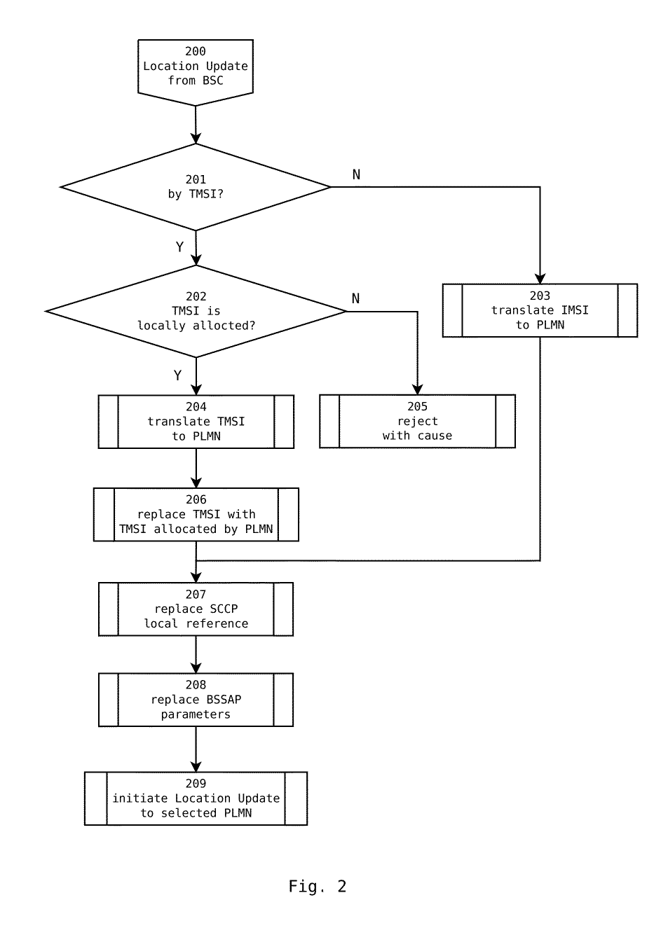

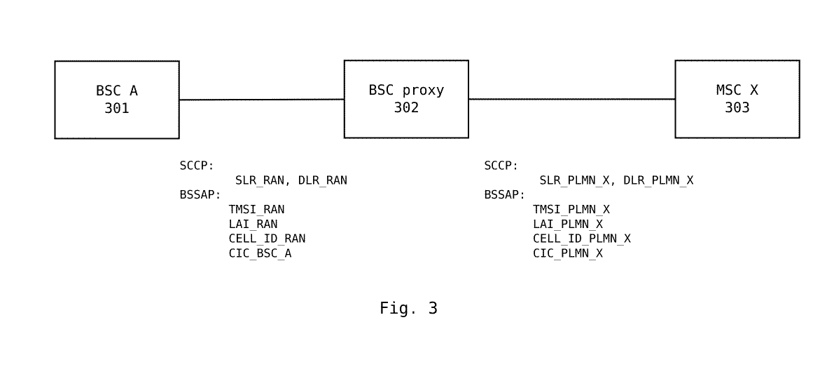

To perform in such a way, BSC-proxy modifies signaling parameters as shown on FIG. 3. During setting up any SCCP connection from BSC 107 to BSC-proxy, the target PLMN is chosen (either by MCC/MNC form IMSI or by a TMSI as described below) as seen on FIG. 2. The BSC-proxy keeps knowledge about SCCP Local References at both sides, ie at BSC (107)-BSC-proxy (106) and BSC-proxy (106)-MSC/VLR (102) interfaces, as well as relations between them, and substitutes SCCP local references when transferring messages between BSCs 107 and MSC/VLRs 102.

As TMSIs are allocated by each MSC/VLR 102 independently, BSC-proxy 106 re-allocates TMSIs towards BSCs 107 itself in such a way, that a newly re-allocated TMSI unambiguously defines PLMN 101, where the given subscriber is to be served. Knowledge about TMSI relation at both sides of BSC-proxy 106 is stored and updated. BSC-proxy 106 replaces TMSIs when transferring signaling messages between BSCs 107 and MSC/VLRs 102.

During initial Location Update procedure, BSC-proxy 106 stores the relation between IMSI and TMSI and updates it. If the initial Location Update is performed by IMSI, IMSI-TMSI relation is obtained by itself. If the Location Update is performed by TMSI, and the given TMSI is not allocated by BSC-proxy 106, BSC-proxy rejects Location Update and forces a subscriber to initiate Location Update with IMSI. As an alternative, if MSC/VLR is known, TMSI can be translated to IMSI with MAP_SEND_IDENTIFICATION procedure.

To make GERAN extension 105 native for any PLMN 101, BSC-proxy 106 substitutes network-specific BSSAP parameters like Location Area Identification and Cell Identification.

Each BSC 107 maps traffic channels, at BTS 108 being served, to CIC values and media endpoints. BSC-proxy 106 converts media and performs voice transcoding, if needed, towards MSC/VLRs, modifies CIC values within BSSAP messages and routes RTP media.

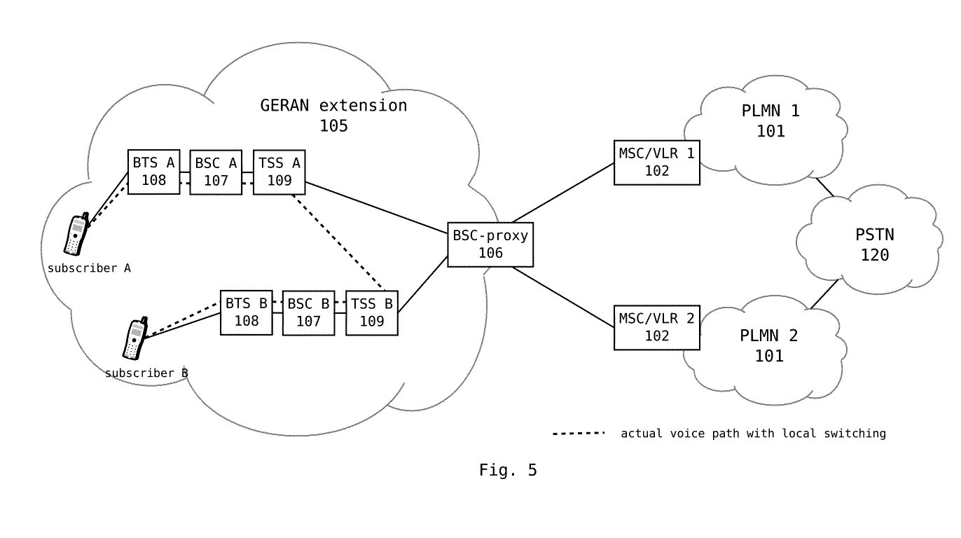

BSC-proxy 106 is capable of performing local switching without any impact on A-interfaces towards MSC/VLRs that are controlling call legs, even when a call involves subscribers being served by different PLMNs 101, as seen on FIG. 5. From any of PLMNs' 101 perspective, its subscriber is served in GERAN extension 105, by a corresponding MSC/VLR 102, and the second party is connected over public telephone network (PSTN) 120. In fact, BSC-proxy 106 detects that both call legs are appeared to be within the same GERAN extension, and media endpoints are cross-connected between Traffic Shaping Software 109 of respective sites. Both calls are billed independently in the respective PLMNs: one PLMN 101 accounts MO call from its subscriber within GERAN extension 105 to outside, the second PLMN 101 receives off-net incoming call to a subscriber within GERAN extension 105.

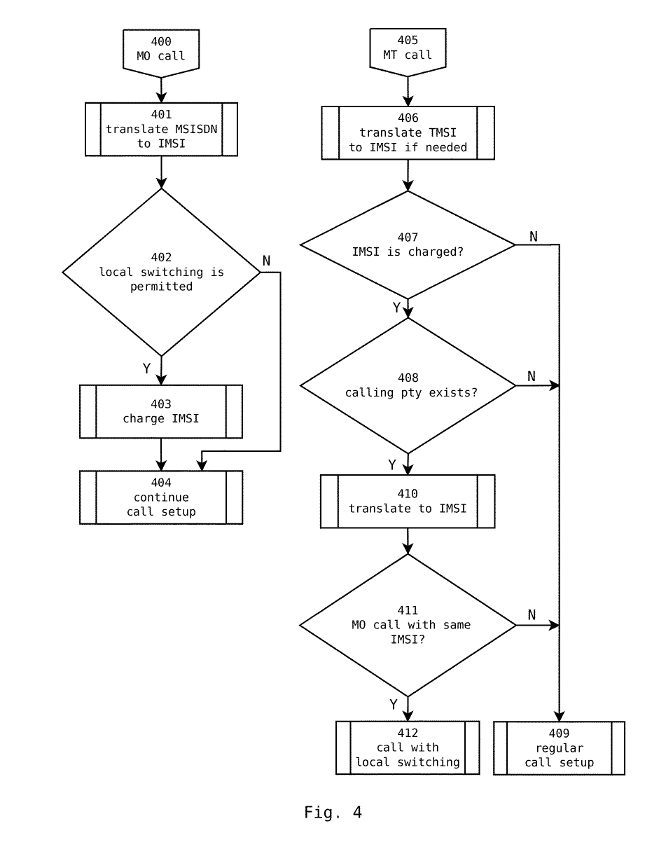

The algorithm of detecting call legs to be cross-connected is shown on FIG. 4. An actual database with MSISDN-IMSI relations is available for BSC-proxy 106. When an outgoing call 400 is placed from GERAN extension 105, the calling party number is converted to IMSI 401. If local switching capabilities are permitted to both parties 402 (ie if lawful interception procedure is not expected), the mentioned IMSI is charged 403. Call setup continues in a regular way over a chosen PLMN 101 as described above.

When a mobile terminated call is delivered 405 to GERAN extension 105, and the IMSI being called is marked as charged 407, and a calling party number, converted to IMSI, matches a corresponding MO call, local switching procedure is performed—media endpoints are interconnected at TSS 109.

Thus, keeping knowledge about IMSI-MSISDN correlation is a must for the given algorithm of local switching implementation.

As a preferred non-intrusive method, a Probe 104 passively monitors SS7 MAP signaling traffic, fetches IMSI-MSISDN pairs and supplies them to BSC-proxy 106 to be stored.

The alternative method of obtaining IMSI-MSISDN knowledge is requesting MSISDN my means of USSD requests: such a technological USSD request is supported by default on most of GSM networks. In the context of the given invention, BSC-proxy 106 emulates USSD request on behalf of a subscriber after Location Update procedure, if MSISDN for the given IMSI is unknown. On USSD response, MSISDN-IMSI pair is stored to be available for further processing.

Another method of obtaining MSISDN-IMSI correlation is emulating a Virtual subscriber as if it is served within GERAN extension 105. When a subscriber with unknown MSISDN performs Location Update, BSC-proxy emulates a call on behalf of the given subscriber to a Virtual one, thus BSC-proxy receives MSISDN of the subscriber as a calling party number when MT call to a Virtual subscriber is delivered back to GERAN extension 105. MSISDN-IMSI pair is stored for further processing.

When local switching is applied within GERAN extension 105, the actual voice traffic is not delivered to PLMN 101, while PLMN assumes that voice traffic to be available for Lawful Interception. To cancel local switching procedure and route traffic in a conventional way, ie through MSC/VLR 102, one of the methods below can be applied. BSC-proxy can either keep the list of IMSIs being monitored locally, or request a permission from a Lawful Interception module to perform local switching on per-call basis.

As an alternative method, local switching can be canceled e.g. if data for Location-Based Service (LBS) is being requested for a given subscriber.

### GLOSSARY OF TERMS USED IN THE SPECIFICATION

BSSAP Base Station Subsystem Application Part
BSC Base station controller
BTS Base transceiver station
CIC C Channel Identification Code
CFU Call forwarding unconditional
CS Circuit switched
GERAN Global system for mobile communications/EDGE radio access network
GPRS GSM packet radio service
GSM Global system for mobile communication (formerly: groupe speciale mobile)
HLR Home location register
HSS Home subscriber server
IMSI International mobile subscriber identity
IP Internet Protocol
LBS Location Based Services
MAP Mobile application part
MCC Mobile Country Code
MNC Mobile Network Code
MSC Mobile Switching Center
MO Mobile originated
MGCP Media Gateway Control Protocol
MEGACO Media Gateway Control
MSC Mobile switching center
MT Mobile terminated
MSISDN Mobile station integrated services digital network number
NGN Next generation network
PLMN Public Land Mobile Network
PRN Provide roaming number
PSTN Public Switched Telephone Network
RAN Radio access network
RTP Real Time Transport Protocol
SCCP Signaling Connection Control Part
SIGTRAN Signaling Transport
SIM Subscriber identification module
SS7 Signaling System N27
TDM Time division multiplex
TMSI Temporary mobile subscriber identity
TSS Traffic Shaping Software
USSD Unstructured supplementary service data
VLR Visitor Location Register

1. In a wireless system that comprises:
a BSC-proxy (“base station controller”-proxy) communicatively coupled with one or more MSC/VLRs belonging to different public land mobile networks (PLMN);
a plurality of base station controllers (BSCs) connected to BSC-proxy with A-over-IP and traffic-shaping software;
a plurality of base stations transceivers (BTSs) co-located with said BSCs to eliminate the need to transfer radio resource management procedures over a backhaul;
signaling probes for monitoring GSM MAP signaling between MSC/VLRs and HLRs;
wherein the BSC-proxy:
a method of concurrently sharing GSM coverage extensions by more than one mobile operator and implementing local switching, comprising the steps of:
providing an A-interface option to each of said PLM Ns;
emulating for each MSC/VLR, a BSC; and for each BSC, the BSC-proxy performing as a single MSC/VLR;
for each SCCP connection request on BSC side, BSC-proxy selects PLMN to serve a given subscriber, by means of requesting, translating and analyzing subscriber identifiers;
BSC-proxy transfers messages between BSCs and MSC/VLRs, and substitutes signaling parameters, such that a GERAN segment is accepted as being exclusively controlled by each of MSC/VLRs and GERAN serves own subset of subscribers;
implementing local switching functionality without any MSC/VLR support, using knowledge about MSISDN-IMSI, and enabling switching subscribers controlled by different MSC/VLRs within the given GERAN extension;
enabling traffic shaping to reduce signaling and voice traffic being transferred over a backhaul between BSC-proxy and BSC.

2. The method of claim 1 further comprising:
setting up routing in BSC-proxy when on SCCP Connection Request on BSC side and choosing the PLMN either by IMSI, where MCC/MNC defines PLMN to be used to process traffic; or by keeping IMSI-TMSI pairs and translating TMSI to IMSI and analyzing MCC/MNC; or by TMSI, re-allocated by BSC-proxy in such a way, that a new TMSI defines PLMN to serve a user; and wherein the BSC-proxy keeps both pairs: IMSI-TMSI, and the relation between TMSI, re-allocated by BSC-proxy, and TMSI, originally allocated by PLMN.

3. The method of claim 1 further comprising:
updating IMSI-TMSI knowledge needed for routing at the BSC-proxy;
rejecting by the BSC-proxy a Location Update from a subscriber with unknown TMSI and forcing a subscriber to perform Location Update by IMSI, or the BSC-proxy requesting IMSI for a given TMSI by means of placing MAP_SEND_IDENTIFICATION request to a VLR;
the BSC-proxy following a TMSI re-allocation procedure; and
re-allocating TMSI by the BSC-proxy on each TMSI re-allocation by the PLMN, in such a way, that an internally allocated TMSI, that is delivered to a subscriber, unambiguously defines a PLMN that is serving a subscriber, and the BSC-proxy keeps a relation between the TMSI from PLMN and the newly allocated TMSI.

4. The method of claim 1 further comprising performing a RAN sharing, wherein:
by BTSs in a given GERAN extension by emitting either a dedicated MCC/MNC or values from a network being extended;
BSC-proxy selecting a PLMN to carry activities for the given subscriber and routing messages and transactions between the BSCs and MSC/VLRs based on IMSIs and TMSIs of subscribers being served;
re-assigning and replacing by the BSC-proxy SCCP Local References, converting CIC values, changing corresponding BSSAP signaling parameters including Location Area Identification and Cell Identification, and substituting TMSIs when transferring signaling messages;
re-allocating by the BSC-proxy TMSIs locally and keeping TMSI-IMSI knowledge to ensure proper routing in order to unambiguously correlate TMSI to a PLMN.

5. The method of claim 1 further comprising performing local switching, wherein the BSC-proxy keeps knowledge needed to translate TMSIs, MSISDNs, IMSIs; and
on MO call setup, BSC-proxy
translates a calling party from TMSI to IMSI and checks whether local switching is permitted;
translates a called party to IMSI and checks whether local switching is permitted; and, if local switching is permitted,
charges IMSI of a called subscriber;
and wherein the BSC-proxy, on MT call setup
verifies if IMSI is charged, and
if a calling party is available and, being translated into IMSI, matches MO call leg, performs local switching.

6. The method of claim 1, further comprising:
obtaining a MSISDN for a given IMSI, needed to perform local switching, with a probe that passively monitors GSM MAP signaling between MSC/VLR and HLR, and fetches the MSISDN for the IMSI.

7. The method of claim 1 further comprising:
obtaining a MSISDN for a given IMSI, needed to perform local switching, wherein the BSC-proxy requests the MSISDN on behalf of a subscriber by means of a USSD request.

8. The method of claim 1 further comprising:
obtaining a MSISDN for a given IMSI, needed to perform local switching, wherein the BSC-proxy obtains the MSISDN by
emulating a virtual subscriber as if being served in the GERAN extension; and
placing a fake call to a virtual subscriber on behalf of a newly-appeared subscriber after performing a Location Update procedure within a GERAN extension; and
receiving the MSISDN as a calling party number of MT call.

9. The method of claim 1 further comprising:
canceling local switching to perform lawful interception, wherein a list of IMSIs being monitored is available, and the BSC-proxy skips local switching if such IMSI is mentioned; or
the BSC-proxy requests a permission from a corresponding node to perform local switching for each subscriber; or
canceling local switching on demand, like when LBS (location-based services) data is requested for any call leg involved.

10. The method of claim 1 further comprising routing of Paging messages,
wherein BSC-proxy:
keeps the knowledge about subscribers' location,
substitutes signaling parameters as said in claim 4 and
delivers paging message exclusively to the desired BSC.
